(19) United States
(12) Patent Application Publication
(10) Pub. No.: US 2007/0045269 A1
(43) Pub. Date: Mar. 1, 2007

(54) Thermal garment and method

(75) Inventor: Robert Vassallo, Mitcham (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignees: Jett (Aust) Pty Ltd, Mitcham (AU); Petatech International Co. Ltd., Taipei (TW)

(21) Appl. No.: 11/390,714

(22) Filed: Mar. 28, 2006

(30) Foreign Application Priority Data
Aug. 12, 2005 (AU) 2005904380

(51) Int. Cl. H05B 3/00; H05B 1/00; H05B 11/00

(52) U.S. Cl. 219/211

(57) ABSTRACT

A heating garment for heating the body of a wearer having a front section adapted to overlie the ventral region of the wearer; a back section adapted to overlie the dorsal thoracic region of the wearer and having a medial portion and lateral portion; electric heating element located in the medial portion of the back section; switching means connected to said heating element and connectable to a portable electric power source, and having at least an off mode and an on mode; and whereby when said switching means is connected to a portable electric power source and is in said on mode said heating element heats to at least 50° C.

### FIELD OF THE INVENTION

The present invention relates to a thermal garment, more particularly, a garment intended to provide supplementary heating to the body of a wearer when in cold atmospheric or aquatic environments. It will be convenient to describe the invention in relation to its application for providing warmth to the body to maintain a suitable core body temperature, although the invention may have wider application, for example for therapeutic use to treat certain musculo-skeletal or other medical conditions.

### BACKGROUND OF THE INVENTION

There are numerous prior art thermal garments which are designed to warm the wearer particularly in cold weather or when immersed in cold water.

Many prior art devices have been disclosed which include a plurality of heating elements positioned in various locations throughout the garment, and which generally are electrically heated by connection to batteries or another power source. Prior art devices known to the applicant generally attempt to provide heating to the body across a large surface area. The prior art devices may attempt to achieve this by providing heating at a temperature approximating a normal core body temperature of about 37° C., or only slightly above that temperature.

It has been found in some instances to be detrimental to provide an external heat source over a large area of the body, and particularly directly to the chest of a wearer in the region of the sternum and particularly when the heat source is at a temperature significantly greater than normal core body temperature. It is believed that providing heating in this manner may induce heat stress or promote arrhythmias by excessive heating by the heart of the wearer.

It would be desirable to provide a thermal garment which can supply an effective heat supplement to the body in a manner which is least likely to induce heat stress to the wearer.

### SUMMARY OF THE INVENTION

In view of the foregoing, there is provided a heating garment for heating the body of a wearer having a front section adapted to overlie the ventral region of the wearer;
a back section adapted to overlie the dorsal thoracic region of the wearer and having a medial portion and lateral portion;
electric heating element located in the medial portion of the back section;
switching means connected to said heating element and connectable to a portable electric power source, and having at least an off mode and an on mode;
and whereby when said switching means is connected to a portable electric power source and is in said on mode said heating element heats to at least 50° C.

Preferably the switching means includes a range of temperature settings. In one embodiment there may be three temperature settings in addition to the off mode. Preferably there is provided a first mode wherein the heating element heats to a temperature of at least 50° C., a second mode wherein the heating element heats to a temperature of at least 60° C. and a third mode wherein the heating element heats to a temperature of at least 70° C. In one embodiment, the heating element may heat to a maximum temperature of about 75° C.

In another aspect of the invention there is provided an aquatic heating garment for heating the body of a wearer having a front section adapted to overlie the body of the wearer;
a back section adapted to overlie the dorsal thoracic region of the wearer and having a medial and a lateral portion;
electric heating element located in the medial portion of the back section, adjacent the body of a wearer and with a wavelength of between 6 to 14 microns;
switching means connected to said heating element and having an off-mode and an on-mode and portable electric power source connected said heating element via said switching means and whereby when said switching means is in said on-mode, said heating element heats to at least 50° C.

In another aspect of the invention, there is provided method of maintaining core body temperature of a human in a cold environment comprising
providing a heating element over at least a portion of the medial dorsal thorasic region of the human;
heating said element to a temperature of at least 50° C.

The applicant has found that by positioning a heating element in a region of a garment which overlies at least the medial dorsal thoracic region, i.e., the thoracic spinal region of the wearer, and optionally also the dorsal lumbar spinal region of the wearer but not other areas of the body such as any ventral regions, and then by heating the element to a relatively high temperature, high heating effectiveness can be achieved without posing physiological hazards to the wearer. Without wishing to be bound by theory, it is thought that by providing a localised high temperature in a region which overlies the spinal column and associated musculature of the wearer, vasodilation in that localised area promotes convective transfer of heat via the body's normal circulation of the blood. It is considered that providing an intense heat to a limited mass of skeletal muscle may result in a less stressful heating method.

In a preferred embodiment, the medial portion overlies the dorsal lumbar region of the wearer as well as the thoracic region. Preferably the heating element comprises two heating zones. One heating zone may heat a thoracic region of the wearer and one may heat a lumbar region of the wearer. Alternatively, both heating zones may heat the thoracic region of the wearer, one positioned higher over the spine of the wearer than the other. Alternatively, one heating zone may heat an upper region of the spine of the wearer, and the other heating zone may be positioned lower down the spine of the wearer.

In a preferred embodiment the garment is an aquatic heating and insulating garment such as a wetsuit, and the heating element forms an integral part of the garment. In this embodiment, the heating element may be attached to a lining layer, and the lining layer may then be attached to the inside of the garment in the medial dorsal thoracic region by any suitable permanent means such as stitching, gluing, heat bonding, or combination of these, or it may be removably attached by any suitable means, for example hook and loop fasteners.

Preferably, the majority of the body of the garment is made from neoprene.

In another embodiment, the garment is constructed from a lightweight, stretchable, slightly insulating or non-insulating fabric and is worn beneath a thermal insulating outer garment. Preferably the lightweight stretchable non-insulating fabric is Lycra™, spandex™ or some similar fabric. Preferably the slightly insulating lightweight stretchable fabric is a neoprene™ having a thickness of about 1 mm or less.

In this embodiment, the outer garment is preferably an aquatic thermally insulating garment such as a wetsuit. Preferably the over garment is made substantially from neoprene™ or a similar waterproof insulating fabric. Where the heating garment is for use in an aquatic environment the power source, heating element and switching means are each preferably waterproof or at least contained within waterproof housings and are connected together by waterproof connectors.

The heating garment and aquatic insulating garments may be two separate garments for several reasons. First it is more convenient to manufacture each garment separately, although it will be appreciated that the heating element could be incorporated in the medial back section of the insulating garment.

Secondly by providing the heating garment separately from the aquatic insulating garment, the insulating garment can be used either with or without the heating garment. Thus, a wide range of existing insulating garments can be used in conjunction with the heating garment.

Thirdly, providing the heating garment separately may facilitate easier donning and removal of both garments. In this embodiment the heating garment may resemble a “rash vest” which is frequently worn beneath a wetsuit and would be used in a similar way.

When used in conjunction with or as an integral part of an aquatic insulating garment such as a wetsuit, a further advantage of the placement of the heating element is that the most common site of entry of cold water into a wetsuit is at the back of the neck and down the spine of the wearer. By having the heating element in this location the chilling effect of water entry can be reduced.

In another embodiment, the garment may be suitable for terrestrial use. In this embodiment the heating element is preferably located beneath an inner lightweight lining of the garment, and the garment includes one or more outer layers. The outer layer or layers preferably include a breathable layer such as a synthetic or natural fleece fabric, and preferably a waterproof outer shell fabric.

Preferably the heating element includes a conductor which is preferably of a sinuate shape. Preferably the conductor comprises an electric heating line and a loop line enveloped in an insulating layer wherein the electric heating line has a resistance to generate heat when a current is passed through it, while the loop line functions as the conductor from one terminal of the power source to a distal end of the heating line. The loop line and the electric heating line are juxtaposed in parallel with each other in the conductor. At a distal end of the heating line the heating line and loop line are electrically coupled. The insulating layer provides insulation between the loop line and the electric heating line to separate current flowing in the two lines. In this arrangement, when current flows through the loop line and the electric heating line, the current flows there-through in a contrary direction. This preferred heating element is described in more detail in United States Patent Application 2003/0047557.

Preferably the heating element included a non-metallic heating fibre which has a high heat transfer efficiency, low power consumption and low electromagnetic interference characteristics. The heating element should be capable of repeated flexing without losing its conductive characteristics. Preferably the heating element has a standard resistance of about 130 ohm per metre. The heating element is preferably located in portions of the garment overlying the back of the wearer so as to raise the core body temperature of the user rather than peripheries such as arms, legs, hands or feet.

Preferably the heating element generates infrared radiation, which will penetrate deeper into the body tissues of the wearer than convective or conductive heat transfer. Infrared radiation may penetrate to a depth of more than 25 mm. More preferably, the infrared radiation produced by the heating element is in the far infrared range, i.e. with a wavelength of between 5.6 to 1000 microns.

It is considered that there are significant therapeutic effects from use of infrared radiation, particularly far infra-red radiation, including:
increased extensibility of collagen tissues;
decrease of joint stiffness;
relief of muscle spasm;
analgesic effect;
increased blood flow;
assistance in resolution of inflammatory infiltrates, edema and exudates, and other therapeutic effects including application in cancer therapy, cardiovascular conditioning and weight loss, coronary artery disease, arteriosclerosis and hypertension.

The garment also preferably includes a portable electric power source connectable to the heating element. The power source is preferably storable in the garment when in use and comprises one or more flexible substantially flat cells. It is important that the cells do not project any sharp edges or corners in the garment due to potential hazards should the wearer be involved in active sports such as surfing, scuba diving or skiing, whilst wearing the garment. The preferred power source is a plurality of lithium polymer batteries, connected in series. More preferably the power source may be 4×3.7 v lithium polymer batteries.

Lithium polymer batteries are lightweight compared to other known power sources and have a degree of flexibility and compactness whereby they can provide sufficient power to heat the heating element yet not pose a risk to the wearer of the garment in the event of a fall.

Preferably each cell may be between 60 to 80 mm wide, between 90 to 110 mm high and between 40 to 50 mm thick, although it will be appreciated that other dimensions may also be suitable. Where the thermal garment is an aquatic garment, as may be worn by surfers or divers, the portable electric power source comprises two pairs of two cells, each pair of cells being located in a pouch preferably in dorsal lumbar lateral portions of the garment. In these locations they are least likely to interfere with the activity of the wearer.

Preferably the power source is capable of maintaining a temperature in said heating element for at least 5 hours, more preferably for about 6 hours.

It will now be convenient to describe the invention with particular reference to a preferred embodiment shown in the drawings, in which:

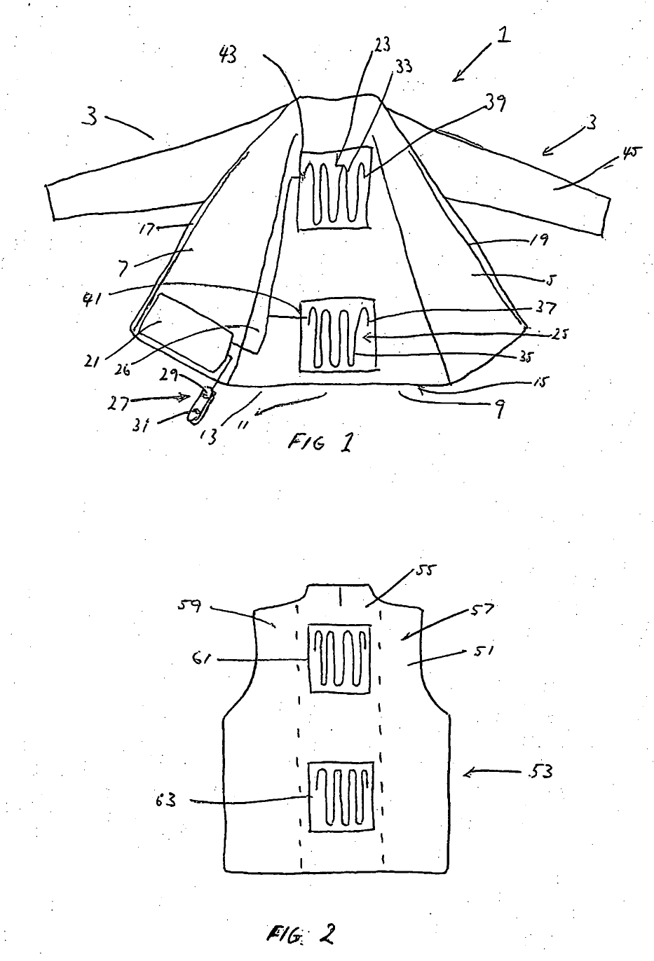

FIG. 1 is a schematic view of a thermal garment of the present invention for terrestrial use, when opened and having the power source located in the garment.

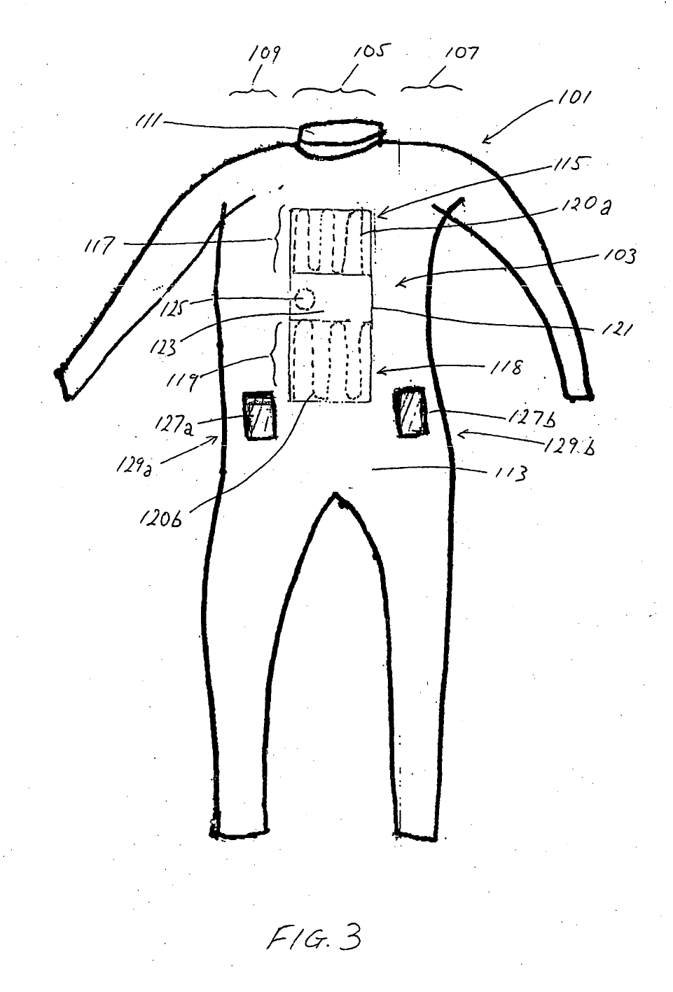

FIG. 2 is a schematic view of another embodiment of the present invention for use in conjunction with an aquatic insulating garment, shown without the front panel visible.

FIG. 3 is a schematic view of an aquatic heating and insulating garment of the present invention showing the positioning of heating elements on the interior dorsal surface of the garment.

In FIG. 1, garment 1 is shown having a pair of sleeves 3, a pair of panels 5, 7 which make up a front section, a back section 9 having a medial portion 11 extending vertically along the back 9 of garment 1, and a pair of lateral portions 13, 15 also extending vertically along back 1 and being substantially parallel to medial portion 11. The front panels 5, 7 are shown opened out to display the inside region of garment 1. Front panels 5, 7 each include half of a zip fastening 17, 19 which may be fastened together to close the garment.

Front panel 7 includes an interior pocket 21 adapted to contain a plurality of lithium polymer cells (not shown). Cells are electrically connected to upper heating element 23 and lower heating element 25 by lead 26, via switching means in the form of controller 27 which is capable of being suspended from garment 1 and is accessible when the garment 1 is being worn. Controller 27 includes LED 29, and switch 31. Preferably, the default position of controller 27 is an off position, where there is an open circuit between cells and heating elements 23, 25. Preferably LED 29 does not illuminate when the controller is in this state. By depressing switch 31 a first time, controller 27 is switched to a first heating mode (low heat) and the circuit closes, allowing the heating elements 23, 25 to be energised such that they heat to a temperature of at least 50° C. It will be appreciated that the heating process may take a few minutes before the desired minimum temperature is reached. In this mode, LED 29 illuminates with a green light. By depressing switch 31 again, controller is switched to a second heating mode (medium heat) and heating elements 23, 25 are energised to a temperature of at least 60° C. In this mode, LED 29 illuminates with a yellow or amber light.

Depressing switch 31 once again switches controller 27 to a third heating mode (high heat) allowing heating elements to reach a temperature of at least 70° C. In this mode, LED 29 displays a red light. Depressing switch 31 once again returns controller 27 to the off mode.

Heating elements 23 and 25 are comprised of a sinuate conductor 33, 35 which contains a fibrous non-metallic heating line and a fibrous non-metallic loop line (not shown). The heating and loop lines are electrically joined together at a distal end 37, 39, and are each joined to either a positive or negative power lead a proximal end 41, 43. A detachable connector (not shown) is located between the cells and the heating elements 23, 25.

Heating elements 23 and 25 are located behind an inner lining material (not shown) of garment 1. Garment 1 includes an outer shell as depicted on sleeves 3,5 comprising a thermal insulating material such as a synthetic fleece, and optionally covered by a waterproof outermost layer. Heating elements 23, 25 can be seen to be located in the garment 1 in locations which, when the garment is worn, will overly the upper thoracic and mid lumbar spinal regions of the wearer.

Turning to FIG. 2, garment 51 is configured as a vest and consists of a lightweight fabric suitable for aquatic use. Although in FIG. 2 the front panel of garment 51 is not shown, the garment may have a ventral zip, or, when garment 51 is made from a very stretchable material such as Lycra™, garment 51 may be easily put on by a wearer in a similar manner to art-shirt or rash vest without the need for a zip. Garment 51 includes a back section 53 having a medial portion 55 and two lateral portions 57, 59 on either side. Upper heating element 61 and lower heating element 63 are located in the medial portion 55. The structure and function of heating elements 61,63 are the same as for the embodiment described in FIG. 1. Importantly however, heating elements 61,63 are joined to a controller and cells (not shown) by way of waterproof detachable connectors (also not shown).

Garment 51 is adapted to be worn beneath a wetsuit or a drysuit, which preferably has an opening at a convenient location to allow a controller to pass there through, such that the wearer has access to the controller to operate the temperature settings.

In FIG. 3, garment 101 comprises a wetsuit made from an insulating material such as Neoprene™. Back panel 103 has a medial region 105 extending from a neck opening 111 to crotch region 113. Back panel 103 also has lateral regions 107 and 109 which similarly extend from neck opening 111 to crotch region 113.

A first heating element 115 is located in an upper region 117 of the medial region 105, such that it overlies the dorsal thorasic region of the wearer of the garment.

A second heating element 118 is located in a lower region 119 of the medial region 105, such that it overlies the dorsal lumbar or lower thorasic region of the wearer of the garment.

Heating elements 115 and 118 consist of sinuate conductors 120a and 120b which create heat when a current is passed therethrough. Sinuate conductors 120a and 120b are fixed to a backing fabric 121, and between conductors 120a and 120b is a space 123 where wires (not shown) attached to each conductor 120a and 120b meet at junction connector 125. A controller (not shown) may be connected to connector 125, as are battery packs 127a and 127b which are located in pockets in lower regions 129a and 129b of lateral regions 109 and 107 respectively. Preferably upper and lower heating elements 115 and 118 are about 100 mm apart, although other spacings may be equally suitable.

Preferably garment 101 is a zipless garment, and the wearer puts on the garment by “climbing through” neck opening 111 which is particularly extensible for this purpose. However, with various modifications to heating elements described below, the garment may include one or more vertical or lateral zips for donning of the garment.

Components of the garment where specific materials have not been described may be made form any materials suitable in the art.

It is to be understood that various modifications, additions and/or alterations may be made to the parts previously described without departing from the spirit of the present invention.

1. A heating garment for heating the body of a wearer having a front section adapted to overlie the ventral region of the wearer;
a back section adapted to overlie the dorsal thoracic region of the wearer and having a medial portion and lateral portion;
electric heating element located in the medial portion of the back section;
switching means connected to said heating element and connectable to a portable electric power source, and having at least an off mode and an on mode;
and whereby when said switching means is connected to a portable electric power source and is in said on mode said heating element heats to at least 50° C.

2. A heating garment according to claim 1 wherein there is provided a portable electric power source.

3. A garment according to claim 2 wherein said power source is capable of maintaining a temperature of at least 50° C. in said heating element for at least 5 hours.

4. A garment according to claim 3 wherein said power source comprises a lithium polymer battery.

5. A garment according to claim 3 wherein said switching means includes a first mode wherein the heating element heats to a temperature of at least 50° C., a second mode wherein the heating element heats to a temperature of at least 60° C., and a third mode where the heating element heats to a temperature of at least 70° C.

6. A garment according to claim 1, wherein said medial portion also overlies the dorsal lumbar region of the wearer, and said heating element is provided in an upper and a lower region of said medial portion.

7. A garment according to claim 1 wherein said heating element emits far infrared radiation with a wavelength between 6 and 14 microns.

8. A garment according to claim 1 wherein said heating element includes a non-metallic conductor.

9. A garment according to claim 5 wherein said garment includes an outer insulating layer and an inner lining layer and said heating element is incorporated within said inner lining layer.

10. A garment according to claim 9 wherein said outer insulating layer is an aquatic thermally insulating layer.

11. A garment according to claim 10 wherein said aquatic thermally insulating layer is made substantially from neoprene.

12. A thermally insulating and heating garment combination comprising a garment according to claim 1 wherein said garment is constructed from a lightweight, stretchable, non-insulating fabric and a thermally insulating outer garment.

13. A garment combination according to claim 12 wherein said outer garment is an aquatic thermally insulating garment.

14. A garment combination according to claim 13 wherein said aquatic outer garment is made substantially from neoprene.

15. A garment combination according to claim 14 wherein said power source, heating element and switching means are each waterproof and are connected by waterproof connectors.

16. An aquatic heating garment for heating the body of a wearer having a front section adapted to overlie the body of the wearer;
a back section adapted to overlie the dorsal thoracic region of the wearer and having a medial and a lateral portion;
electric heating element located in the medial portion of the back section, adjacent the body of a wearer and with a wavelength of between 6 to 14 microns;
switching means connected to said heating element and having an off-mode and an on-mode as portable electric power source connected said heating element via said switching means and whereby when said switching means is in said on-mode, said heating element heats to at least 50° C.

17. A method of maintaining core body temperature of a human in a cold environment comprising
providing a heating element over at least a portion of the medial dorsal thorasic region of the human;
heating said element to a temperature of at least 50° C.

18. A method according to claim 17 wherein said heating element is heated to a temperature of at least 60° C.

19. A method according to claim 18 wherein said heating is heated to a temperature of at least 70° C.

20. A method according to claim 17 wherein said heating element is incorporated in a garment as claimed in claim 1 or claim 16.
